(19) United States
(12) Patent Application Publication
(10) Pub. No.: US 2026/0302882 A1
(43) Pub. Date: Oct. 1, 2026

(54) MOTOR

(71) Applicant: LG INNOTEK CO., LTD., Seoul (KR)

(72) Inventors: Moon Jae LEE, Seoul (KR); Heok Jin PARK, Seoul (KR)

(73) Assignee: LG INNOTEK CO., LTD., Seoul (KR)

(21) Appl. No.: 19/478,341

(22) PCT Filed: May 31, 2024
(86) PCT No.: PCT/KR2024/007470

§ 371 Date: Oct. 24, 2025

(30) Foreign Application Priority Data
Jun. 1, 2023 (KR) 10-2023-0070965

(51) Int. Cl. H02K 7/10; H02K 7/00

(52) U.S. Cl. CPC H02K 7/10; H02K 7/003

(57) ABSTRACT

The present invention may provide a motor which includes a shaft, a rotor coupled to the shaft, a stator disposed to correspond to the rotor, a rotating part fixed to the shaft, and a locking part disposed to be spaced apart from the shaft in a radial direction, wherein the locking part includes a stopper which is movable toward the rotating part, and when a signal is applied to the locking part, the stopper is engaged with the rotating part in a concave-convex manner to restrict rotation of the shaft.

### TECHNICAL FIELD

The present invention relates to a motor.

### BACKGROUND ART

An electronic braking system of a vehicle is a system which brakes a vehicle through operation of a motor and a speed reducer and has advantages of light, superior responsiveness, and less installation space restraint compared to a mechanical braking system. In addition, an electric parking brake of a vehicle is a device which automatically operates using an actuator according to an operation state of a vehicle even when a driver does not manually operate the vehicle.

Such an electric parking brake may be formed in a structure in which a shoe in a drum-in-hat (DIH) of a wheel extends due to tension generated by pulling a parking cable through rotation of a motor to secure a braking force or a spindle moves a piston forward through rotation of a motor to bring a disk and a pad into close contact with each other to secure a braking force.

Since the structure of the electric parking brake should be added to the electronic braking system in order to implement an electric parking brake function, there are problems that a large installation space is required, and a structure of related parts such as a speed reducer is complicated.

### DESCRIPTION OF INVENTION

### Technical Problem

Therefore, the present invention is to solve the above-described problems and is directed to providing a motor through which a parking brake function is added to an electronic braking system to simplify a structure of an entire braking system.

Objectives to be achieved by the present invention are not limited to the above-described objectives, and other objectives, which are not described above, may be clearly understood by those skilled in the art through the following specification.

### Technical Solution

An embodiment provides a motor which includes a shaft, a rotor coupled to the shaft, a stator disposed to correspond to the rotor, a rotating part fixed to the shaft, and a locking part disposed to be spaced apart from the shaft in a radial direction, wherein the locking part includes a stopper which is movable toward the rotating part, and when a signal is applied to the locking part, the stopper is engaged with the rotating part in a concave-convex manner to restrict rotaion of the shaft.

Portions of the rotating part and the locking part may overlap in a circumferential direction.

The stopper may be moved in an axial direction and coupled to the rotating part in the concave-convex manner.

The rotating part may include a plurality of groove portions, and the stopper may be inserted into one of the groove portions.

At least a portion of the stopper may overlap a groove portion in an axial direction.

The groove portions may be formed at predetermined intervals to be concave inward from an edge of the rotating part.

At least a portion of an inner surface of the groove portion which comes into contact with the protrusion may be formed to be inclined.

The stopper may overlap the stator in an axial direction.

The locking part may include a cylinder disposed outside the stopper and a coil disposed in the cylinder.

The locking part may further include an elastic member disposed between the cylinder and the stopper.

The motor may further include a body which accommodates the stator and the rotor and of which a portion is open and a cover which covers the body, wherein the cover may include an accommodation part which accommodates the locking part.

### Advantageous Effects

According to one embodiment of the present invention, since a parking brake function is added to an electronic braking system, there is an advantage of simplifying a structure of an entire braking system.

According to one embodiment of the present invention, since a separate component of a parking brake is not required because a shaft of a motor of an electronic braking system is directly restrained, there are advantages of reducing an installation space and the number of parts.

According to one embodiment of the present invention, since a shaft is restrained by a stopper in a solenoid type, there is an advantage of more easily implementing a parking brake function.

### DESCRIPTION OF DRAWINGS

FIG. 1 is a view illustrating a motor according to an embodiment.

FIG. 2 is a side cross-sectional view illustrating the motor shown in FIG. 1, and FIG. 3 is an exploded view illustrating the motor shown in FIG. 1.

FIG. 3 is an exploded view illustrating the motor shown in FIG. 1.

FIG. 4 is an exploded view illustrating a locking part.

FIG. 5 is a plan view illustrating a stopper shown in FIG. 3.

FIG. 6 is a side cross-sectional view illustrating the locking part.

FIG. 7 is a view illustrating a shaft to which a rotating part is coupled.

FIG. 8 is a view illustrating the rotating part.

FIG. 9 is a view illustrating a cover of a housing.

FIG. 10 is a view illustrating the shaft which is unlocked in a state in which a current is not applied to the locking part.

FIG. 11 is a view illustrating positions of a groove portion and a protrusion in a state in which the shaft is unlocked.

FIG. 12 is a view illustrating the shaft restrained by the stopper when power is applied to the locking part.

FIG. 13 is a view illustrating the protrusion coupled to the groove portion.

### MODES OF THE INVENTION

Hereinafter, exemplary embodiments of the present invention will be described in detail with reference to the accompanying drawings.

However, the technical spirit of the present invention is not limited to the few embodiments which will be described and may be implemented in a variety of different forms, and one or more components of the embodiments may be selectively combined, substituted, and used within the range of the technical spirit of the present invention.

In addition, unless clearly and specifically defined otherwise by the context, all terms (including technical and scientific terms) used herein can be interpreted as having meanings customarily understood by those skilled in the art, and the meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless specifically indicated otherwise by the context, singular forms include plural forms, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” may be used.

The terms are only to distinguish one component from another component, and the essence, order, and the like of the components are not limited by the terms.

In addition, it should be understood that, when a first component is referred to as being “connected,” “coupled,” or “linked” to a second component, such a description may include both a case in which the first component is directly connected, coupled, or linked to the second component, and a case in which the first component is connected, coupled, or linked to the second component with a third component disposed therebetween.

In addition, when a first component is described as being formed or disposed “on (above)” or “under (below)” a second component, such a description includes both a case in which the two components are formed or disposed in direct contact with each other and a case in which one or more other components are interposed between the two components. In addition, when the first component is described as being formed “on (above) or under (below)” the second component, such a description may include a case in which the first component is formed at an upper side or a lower side with respect to the second component.

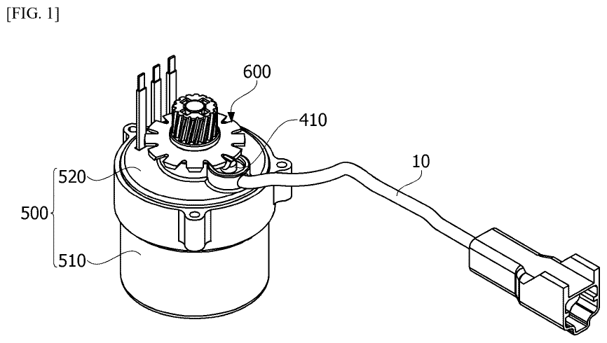

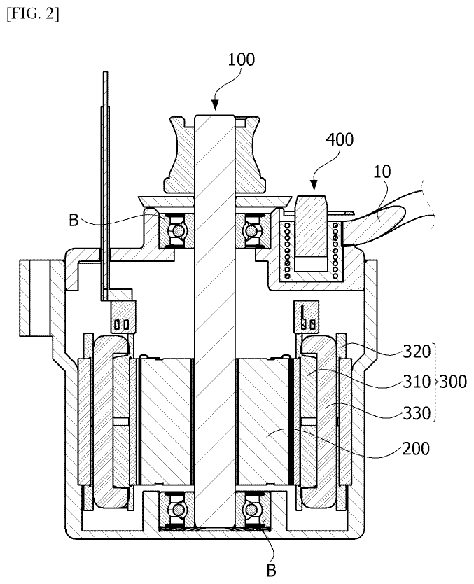

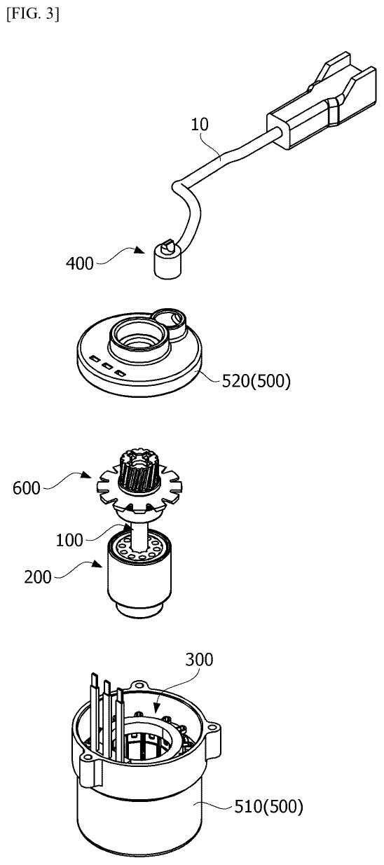

FIG. 1 is a view illustrating a motor according to an embodiment, FIG. 2 is a side cross-sectional view illustrating the motor shown in FIG. 1, and FIG. 3 is an exploded view illustrating the motor shown in FIG. 1.

Referring to FIGS. 1 to 3, the motor according to the embodiment may include a shaft 100, a rotor 200, a stator 300, a locking part 400, a housing 500, and a rotating part 600.

Hereinafter, a circumferential direction and a radial direction are defined based on an axial center of the motor.

Hereinafter, the motor has a feature of a parking brake function in addition to a brake function of a vehicle.

Both ends of the shaft 100 may be rotatably supported by a bearing in an axial direction. In the shaft 100, portions of which outer diameters are different from each other may be separately disposed in the axial direction.

The rotor 200 rotates through an electrical interaction with the stator 300. The rotor 200 may be disposed inside the stator 300 to correspond to the stator 300. The rotor 200 may include a rotor core 210 and a magnet 220.

The stator 300 is disposed outside the rotor 200. The stator 300 may include a stator core 310, an insulator 320, and a coil 330. The insulator 320 is mounted on the stator core 310. The coil 330 may be wound around the insulator 320. The insulator 320 is disposed between the coil 330 and the stator core 310 and electrically insulates the stator core 310 from the coil 330.

The locking part 400 is disposed on the housing 500. The locking part 400 is a part which implements a parking brake function by restraining the shaft 100 from rotating when the vehicle is stopped and a signal is applied to the locking part 400. The locking part 400 may be connected to a connector 10. The locking part 400 may be disposed outside the housing 500. The locking part 400 may be disposed to overlap the rotor 200 or the stator 300 in the axial direction. In addition, the locking part 400 may be disposed to overlap a bearing B in the radial direction.

The housing 500 is disposed outside the stator 300. The housing 500 may include a housing body 510 formed in a cylindrical shape and a cover 520 which covers the housing body 510.

The rotating part 600 is coupled to the shaft 100. The rotating part 600 is disposed outside the housing 500. The rotating part 600 is integrally rotated with the shaft 100 when the shaft 100 rotates. The rotating part 600 may be disposed just above the bearing B. The rotating part 600 is coupled to the locking part 400 in a concave-convex manner and serves to selectively restrain the shaft 100 according to a position of a stopper 410 of the locking part 400. The rotating part 600 is disposed to overlap the rotor 200 in the axial direction.

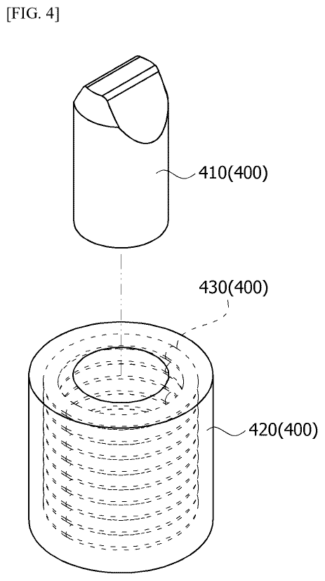

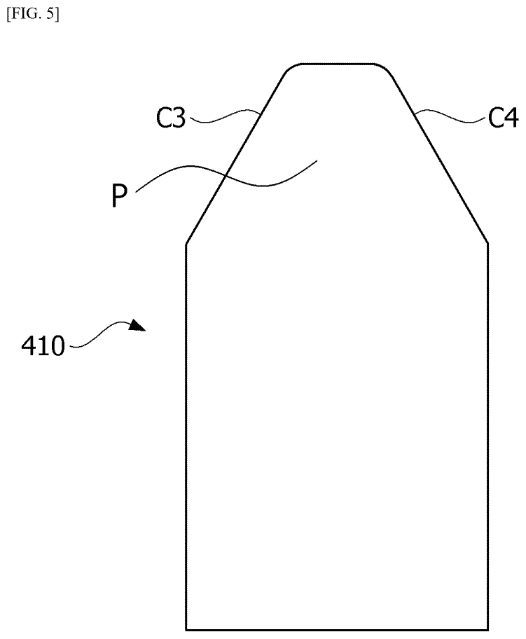

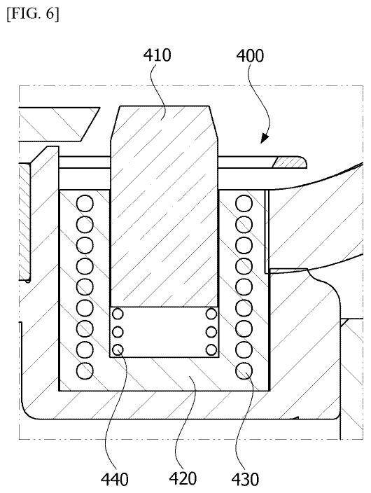

FIG. 4 is an exploded view illustrating the locking part 400, FIG. 5 is a plan view illustrating the stopper 410 shown in FIG. 3, and FIG. 6 is a side cross-sectional view illustrating the locking part 400.

Referring to FIGS. 4 to 6, the locking part 400 may include the stopper 410, a cylinder 420, a coil 430, and an elastic member 440.

The stopper 410 is disposed inside the cylinder 420. The cylinder 420 may be a cylindrical member in which a hollow is formed. The coil 430 may be disposed in the cylinder 420. The stopper 410 is disposed in the cylinder 420 and straightly reciprocates. In the stopper 410, a contact region with the rotating part 600 is formed such that the stopper 410 moves in the axial direction to prevent the shaft 100 from rotating.

The stopper 410 includes a protrusion P at a front end thereof. In the protrusion P, a contact region with the shaft 100 is formed such that the protrusion P is inserted into a groove portion G of the rotating part 600 to prevent the shaft 100 from rotating.

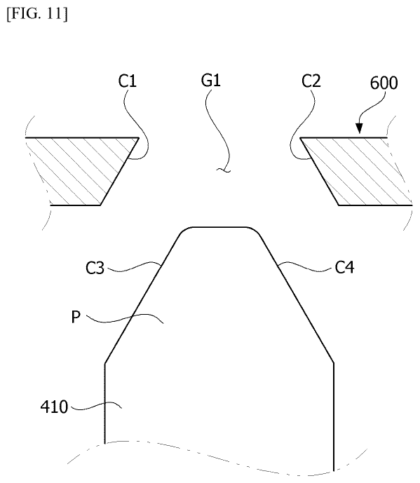

The protrusion P may include a third contact surface C3 and a fourth contact surface C4. The third contact surface C3 may come into contact with a first contact surface C1 (see FIG. 11) of the groove portion G. The fourth contact surface C4 may come into contact with a second contact surface C2 (see FIG. 11) of the groove portion G. The third contact surface C3 and the fourth contact surface C4 may be disposed to be inclined toward each other in a direction perpendicular to the axial direction.

The protrusion P of the stopper 410 may be formed in a straight shape in a longitudinal direction of the stopper 410.

The stopper 410 may be disposed to overlap the stator 200 in the axial direction. The stopper 410 may be disposed to overlap the bearing B in the radial direction.

The stopper 410 may be formed of a metal material.

The elastic member 440 may be disposed between the cylinder 420 and the stopper 410 in the axial direction. The elastic member 400 may be a spring having a restoring force when elongated.

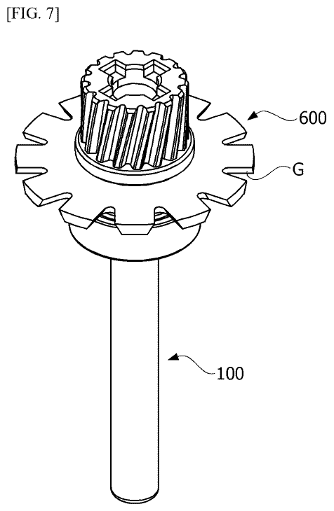

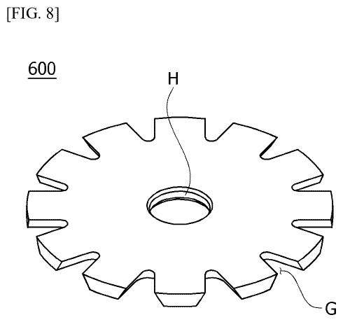

FIG. 7 is a view illustrating the shaft 100 to which the rotating part 600 is coupled, and FIG. 8 is a view illustrating the rotating part 800.

Referring to FIGS. 7 and 8, the rotating part 600 may be a member formed in a disk shape. The rotating part 600 may include a hole H through which the shaft 100 passes. The hole H may be disposed in a central portion of the rotating part 600. In addition, the rotating part 600 may include a plurality of groove portions G. The groove portions G may be formed to be concave inward from an edge of the rotating part 600. The plurality of groove portions G may be disposed at predetermined distances along the edge of the rotating part 600.

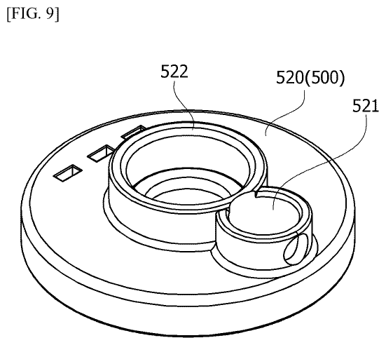

FIG. 9 is a view illustrating a 520 cover of the housing 500.

Referring to FIG. 9, the housing 500 may include an accommodation part 521 which accommodates the locking part 400. The locking part 400 is positioned inside the accommodation part 521. In addition, the housing 500 may include a bearing pocket portion 522 which accommodates the bearing B. The accommodation part 521 may be disposed adjacent to the bearing pocket portion 522.

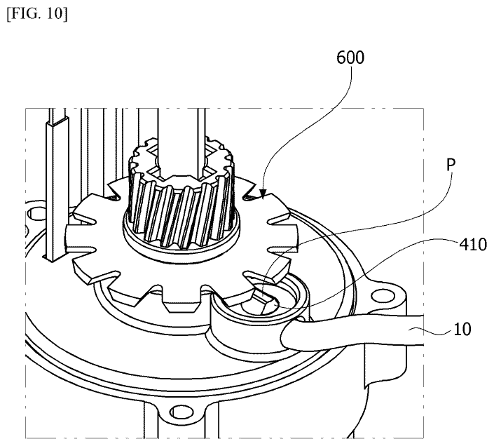

FIG. 10 is a view illustrating the shaft 100 which is unlocked in a state in which a current is not applied to the locking part 400, and FIG. 11 is a view illustrating positions of the groove portion G and protrusion P in a state in which the shaft 100 is unlocked.

Referring to FIGS. 10 and 11, when the vehicle is traveling or is stopped, and there is no additional signal, power is not applied to the coil 430, and the protrusion P of the stopper 410 is positioned to be spaced apart from the groove portion G in the axial direction due to the restoring force of the elastic member 440. The shaft 100 is not restrained by the stopper 410 and is rotated due to the electromagnetic interaction between the rotor 200 and the stator 300.

The groove portion G may include the first contact surface C1 and the second contact surface C2 which come into contact with the protrusion P. The first contact surface Cl and the second contact surface C2 are disposed to face each other. The protrusion P is positioned between the first contact surface C1 and the second contact surface C2. The first contact surface C1 and the second contact surface C2 may be disposed to be inclined toward each other to increase a separation distance toward an entrance of the groove portion G.

The groove portion G may be disposed to overlap the rotor 200 in the axial direction.

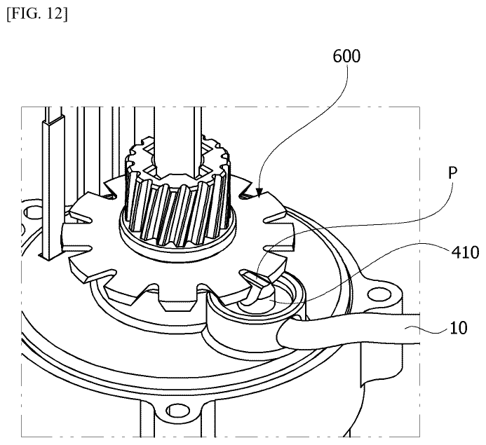

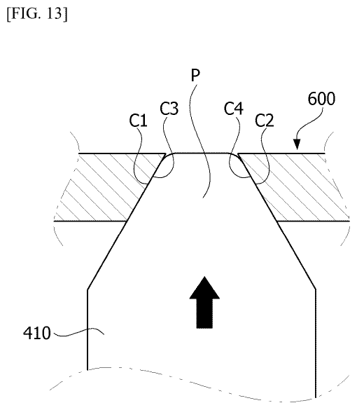

FIG. 12 is a view illustrating the shaft 100 restrained by the stopper 410 when power is applied to the locking part 400, and FIG. 13 is a view illustrating the protrusion P coupled to the groove portion G.

Referring to FIGS. 12 and 13, when the vehicle is in a parked state, and a related signal is input to a parking brake to apply power to the coil 430, the stopper 410 is straightly moved along the first cylinder 420 due to an electromagnetic interaction between the coil 430 and the stopper 410. The stopper 410 overcomes the restoring force of the first elastic member 440 and straightly moves toward the groove portion G. The stopper 410 moves until the protrusion P of the stopper 410 is completely inserted into the groove portion G. A portion of the protrusion P overlaps the groove portion G in the circumferential direction.

The protrusion P is inserted into the groove portion G, and a contact region is formed between the rotating part 600 and the stopper 410 to prevent the rotating part 600 from rotating. That is, the first contact surface C1 comes into contact with the third contact surface C3, the second contact surface C2 comes into contact with the fourth contact surface C4, and thus rotation of the shaft 100 is restrained by the stopper 410.

As described above, since the stopper 410 directly restrains the shaft 100, there is an advantage of implementing a parking brake function without a structure in which a separate parking brake is formed.

The motor according to one exemplary embodiment of the present invention has been described above with reference to the accompanying drawings.

The above-described embodiments should be considered in a descriptive sense only and not for purposes of limitation, and the scope of the present invention is defined not by the detailed description but by the appended claims. In addition, it should be interpreted that the scope of the present invention encompasses all modifications and alterations derived from meanings and the scope and equivalents of the appended claims.

1. A motor comprising:
a shaft;
a rotor coupled to the shaft;
a stator disposed to correspond to the rotor;
a rotating part fixed to the shaft; and
a locking part disposed to be spaced apart from the shaft in a radial direction,
wherein the locking part includes a stopper which is movable toward the rotating part, and
when a signal is applied to the locking part, the stopper is engaged with the rotating part in a concave-convex manner to restrict rotaion of the shaft.

2. The motor of claim 1, wherein portions of the rotating part and the locking part overlap in a circumferential direction.

3. The motor of claim 1, wherein the stopper is moved in an axial direction and coupled to the rotating part in the concave-convex manner.

4. The motor of claim 3, wherein:
the rotating part includes a plurality of groove portions; and
the stopper is inserted into one of the groove portions.

5. The motor of claim 1, wherein at least a portion of the stopper overlaps a groove portion in an axial direction.

6. The motor of claim 4, wherein the groove portions are formed at predetermined intervals to be concave inward from an edge of the rotating part.

7. The motor of claim 4, wherein at least a portion of an inner surface of the groove portion which comes into contact with the protrusion is formed to be inclined.

8. The motor of claim 1, wherein the stopper overlaps the stator in an axial direction.

9. The motor of claim 1, wherein the locking part includes:
a cylinder disposed outside the stopper; and
a coil disposed in the cylinder.

10. The motor of claim 9, wherein the locking part further includes an elastic member disposed between the cylinder and the stopper.

11. The motor of claim 1, further comprising:
a body which accommodates the stator and the rotor and of which a portion is open; and
a cover which covers the body,
wherein the cover includes an accommodation part which accommodates the locking part.
